(19) United States
(12) Patent Application Publication
(10) Pub. No.: US 2016/0267435 A1
(43) Pub. Date: Sep. 15, 2016

(54) WATERCRAFT MOORING AND MANAGING BASED ON WATERCRAFT REMOTE IDENTIFICATION

(71) Applicant: Gilbert Eid, Kahhaleh (LB)

(72) Inventor: Gilbert Eid, Kahhaleh (LB)

(21) Appl. No.: 15/163,709

(22) Filed: May 25, 2016

Related U.S. Application Data
(63) Continuation-in-part of application No. 14/258,584, filed on Apr. 22, 2014.
Application No. 14/258,584 is a continuation-in-part of application No. 14/172,025, filed on Feb. 4, 2014.

(51) Int. Cl. G06Q 10/10; G06Q 20/14; G06Q 30/02; G06Q 20/10

(52) U.S. Cl. CPC G06Q 10/109; G06Q 20/102; G06Q 20/14; G06Q 30/0283

(57) ABSTRACT

Methods and systems for remote watercraft identification and mooring facilitation are provided. This technology requires installation of identification tags, such as RFID tags, on watercrafts, which actively or passively emit identification signals conveying watercraft identifiers. When a watercraft arrives to a marina, a watercraft identifier can be acquired by an electronic device from the watercraft. This allows for verifying the watercraft and obtaining relevant watercraft information. A captain of the watercraft can send a mooring inquiry to the electronic device, in response to which the electronic device generates a contract offer with price estimated based on the watercraft identifier and data obtained from the mooring inquiry. The contract offer is electronically sent to the captain for acceptance. If accepted, the electronic device provides to the captain electronic map data with an indication of a dock allocated for mooring.

### CROSS-REFERENCE TO RELATED APPLICATIONS

This application is a Continuation-in-Part application of U.S. utility, non-provisional patent application Ser. No. 14/172,025 filed Feb. 4, 2014, entitled “Remote Identification of Vehicle Status” and U.S. utility, non-provisional patent application Ser. No. 14/258,584 filed Apr. 22, 2014, entitled “Parking and Tollgate Payment Processing Based on Vehicle Remote Identification,” which are incorporated herein by reference in their entirety for all purposes.

### TECHNICAL FIELD

This disclosure relates generally to vehicle identification and, more specifically, to the wireless technology for remote identifying of watercrafts, which can be used upon docking of the watercrafts in marinas and ports.

### DESCRIPTION OF RELATED ART

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Finding a dock or slip in a marina for mooring a watercraft can be a challenging task for captains and owners of the watercraft, especially when travelling. Typically, the docking process requires for the captain of a watercraft to be docked to exchange documentation with an administration of the marina of interest. The administration may need to verify the watercraft and generate a short-term or long-term contract offer for the captain. The offer is then reviewed by the captain and either accepted or declined. When the offer is accepted by the captain, the administration allocates a dock or slip in the marina, and the captain needs to forward the watercraft to the allocated dock or slip. Forwarding the watercraft in an unknown marina can be another challenging task to perform.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Various embodiments of the present disclosure provide methods and systems for effective vehicle identifications. The term “vehicle” shall mean any water-floating transportation means, including watercraft, boats, yachts, water-floating devices, and the like. The present technology involves installation of wireless passive or active identification tags, such as, but not limited to, radio-frequency identification (RFID) tags, Wi-Fi tags, Bluetooth tags, and so forth, on all or certain vehicles within a dedicated area such as a country, state, district, or private land or parcel. The identification tag can be configured to emit identification signals, which include a vehicle identifier and, optionally, other information related to the vehicle and/or its owner. The identification signal can be propagated across a relatively short distance, for example, less than 300 feet or even less than 100 feet when the vehicle is in an unassisted view of a human eye.

The present technology may also employ the use of electronic devices, such as a portable computer, tablet computer, wireless telephone, or smart phone, which includes a reader or antenna for wirelessly communicating with the identification tags installed on vehicles. For these ends, the electronic device may run a dedicated software application (e.g., a mobile application) to implement the methods described herein and other processes including communication with the identification tags and remote databases to identify a particular vehicle, make reports, process payments, facilitate communication with marina or port authorities, find a dock or clip for docking, mooring or parking, assisting in making a contract between the vehicle owner and marina or port authorities, facilitating navigating in marina and ports, and so forth.

In one aspect of the present disclosure, a method for remote watercraft identification and mooring facilitation is provided. An example method comprises acquiring, by a first electronic device, a vehicle identification signal emitted by a vehicle identification tag secured to a watercraft. The vehicle identification signal can convey a vehicle identifier associated with the watercraft. The method further comprises the step of receiving a mooring inquiry by a second electronic device or server from the first electronic device. The mooring inquiry can comprise credentials of a captain of the watercraft. The method further comprises the step of generating, by the second electronic device, a response message to the mooring inquiry. The response message comprises a price estimation associated with a contract offer for mooring services. The method further comprises the step of sending, by the second electronic device or the server, the response message to the first electronic device. The method further comprises the step of receiving a confirmation message, by the second electronic device from the first electronic device or the server. The method further comprises the step of sending map data by the second electronic device or the server to the first electronic device. The map data can comprise a plan of a marina and an indication of a dock allocated for mooring the watercraft.

In certain embodiments, the second electronic device is associated with the marina and maintained substantially on premises of the marina. The first electronic device can be associated with the watercraft. The second electronic device can be maintained substantially on the watercraft and operated by a captain of the watercraft. In some embodiments, the method further comprises the step of verifying, in response to the mooring inquiry, a status of watercraft based on the vehicle identification signal. The verification can be performed through the server, which maintains a database of registered vehicles.

In some embodiments, the method further comprises the step of acquiring, in response to the mooring inquiry, watercraft information based on the vehicle identification signal. The watercraft information can be acquired from the server maintaining a database of registered vehicles. The watercraft information can include watercraft parameters, watercraft crew information, watercraft documentation, watercraft insurance information, and contact information.

In some embodiments, the method further comprises the step of allocating, by the first electronic device or the server, a dock for mooring the watercraft based on the confirmation message, current occupancy of the marina, and watercraft parameters acquired based on the vehicle identification signal. In some embodiments, the method further comprises the steps of acquiring, by the first electronic device, a current geographical location of the watercraft, acquiring, by the first electronic device, the vehicle identification signal emitted by the vehicle identification tag secured to the watercraft, wherein the vehicle identification signal conveys the vehicle identifier associated with the watercraft, sending, by the first electronic device, a report message to the server maintaining a database of registered vehicles, the report message includes the current geographical location of the watercraft associated with the vehicle identifier and a past route taken by the watercraft, and providing access to the report message by the server or the second electronic device to an owner of the watercraft based on credentials of the owner and a clearance level of the owner of the watercraft.

In some embodiments, the method further comprises the step of sending a billing inquiry, by the first electronic device or the second electronic device, to a payment processing service, wherein the billing inquiry comprises the vehicle identifier and billing information. The billing inquiry can cause the payment processing service to perform a monetary transaction based on the billing information and in accordance with one or more predetermined rules and against an account associated with an owner or the captain of the watercraft.

In certain embodiments, the response message causes the first electronic device to display a user interface. The user interface shows the contract offer, the price estimation, and prompts the captain of the watercraft to make an input indicating his acceptance or denial of the contract offer.

In some embodiments, the method further comprises the step of navigating, by the first electronic device, the watercraft based on the map data obtained from the first electronic device and current geographical location of the watercraft determined by the second electronic device.

In further example embodiments, steps of methods described herein may be stored on a computer readable storage medium having program instructions embodied thereon, with the program instructions executable by a processor in a computing device. In yet further exemplary embodiments, a system, modules, subsystems, or devices can be adapted to perform the method steps. Other features and exemplary embodiments will be evident from the detailed description provided below.

### BRIEF DESCRIPTION OF DRAWINGS

Embodiments are illustrated by way of example and not limitation in the figures of the accompanying drawings, in which like references indicate similar elements and in which:

FIG. 1A shows a high-level block diagram illustrating a system environment within which methods for vehicle identification may be implemented.

FIG. 1B shows a high-level block diagram illustrating a system environment within which methods for watercraft identification, mooring and managing may be implemented.

FIG. 2 is a diagrammatic representation of an example electronic device in the form of a computer system within which a set of instructions for the electronic device to perform any one or more of the methodologies discussed herein is executed.

FIG. 3 shows a high-level process flow diagram of a method for vehicle identification according to methodologies discussed herein.

FIGS. 4-10 illustrate schematic diagrams of various graphical user interfaces (GUIs) displayable by an electronic device at different stages of vehicle status identification, according to embodiments of the present disclosure.

FIG. 11 shows an exemplary data structure of database of registered vehicles.

FIG. 12 shows a flow diagram if an example method for remote watercraft identification and facilitation in mooring and managing the watercraft according to one example embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors, controllers or other specially designed application-specific integrated circuits (ASICs), programmable logic devices, or various combinations thereof. In particular, the methods described herein may be implemented by a series of computer-executable instructions residing on a storage medium such as a disk drive, solid-state drive or on a computer-readable medium.

In general, embodiments of the present disclosure implement a technology for vehicle identification and, more specifically, identification of a vehicle status. The term “vehicle” as used herein shall mean any water-floating transportation means, including watercrafts, boats, ships, yachts, water-floating devices, and so forth. The term “vehicle” and “watercraft” can be used interchangeably.

The technology involves installation of identification tags on vehicles, which can actively or passively emit identification signals conveying vehicle identifiers and, optionally, other information. A user such as a member of the public or an interested party, such as a sale personnel, vehicle owner, customer, police officer or parking officer, can be equipped with an electronic device suitable for receiving identification signals from the device installed on the vehicle and process the signals in order to identify the vehicle's status. The vehicle status can be indicative of whether a particular vehicle is stolen, wanted, associated with specific criminal offences, or if a vehicle is parked, on travel, unlisted (i.e., a fake signal), pass, and so forth. The vehicle status can be obtained by querying remote databases maintained by at least one server. Once the vehicle status is determined, it can be displayed or presented to the member of the public or other interested parties in various ways (e.g., on a display of the electronic device or by an audio signal).

The present technology can also enable its users to make reports when, for example, the member of the public or another interested party finds a vehicle not emitting an identification signal. Lack of this signal may be interpreted as illegal removal of identification tags from a vehicle. The user can visually identify the non-emitting vehicle since the device displays a description of the nearby vehicles. The vehicle not emitting any signal is not on the list. Another way to identify a non-emitting vehicle is by counting vehicles either manually or with the help of specific hardware. To these ends, the electronic device may enable its user to generate and send an electronic message to the server or relevant authorities including an identification of the location where a suspicious vehicle is located, a photo of a vehicle, and other related information or commentaries.

Accordingly, provided all vehicles within a specific area, such as a nation, country, state, city, district, county, or otherwise enclosed area, such as a private land or premises, are equipped with the identification tags, the present technology allows efficient detection of vehicle statuses. It is a very convenient and straightforward technology for use by the general public, merchants, government officials, military and police officers, and other authorities. The vehicle status may not only include information indicative of a particular vehicle being stolen or wanted, but also indicate whether any fines or warrants are outstanding, whether the vehicle passed a required inspection, whether the vehicle is associated with any civil or criminal offences, and so forth. Users will have access to information according to their level of clearance.

It is also important that, in certain embodiments, vehicle owners can themselves set vehicle statuses in the database. For example, the vehicle owners may set the vehicle status to “parked” when they park their vehicles. In other embodiments, the vehicle owners may set the vehicle status to “on travel” to designate that their intention is to remove a stopped vehicle from a dedicated area within a short period of time. Accordingly, this technology makes it impossible to take advantage of stealing identification tags from parked vehicles and placing them on stolen vehicles. The present technology allows citizens to determine whether vehicles they own have any outstanding fines, the date of their next vehicle service, permits associated with the vehicle, such as tinted windows, and so forth.

Furthermore, some embodiments of the present technology allow spotting attempts to duplicate identification tags. This “Chinese wall” option provides for interaction between a database of stolen vehicles and a database of vehicle information based upon analysis of vehicle location data and corresponding vehicle identifiers. More specifically, in an example embodiment, an individual may request information concerning a particular vehicle within a distance range using his electronic device. For these ends, the electronic device acquires a vehicle identifier associated with the vehicle of interest and sends a request to a remote server. This request includes the vehicle identifier and a current location of the electronic device. Another server, which maintains vehicle data, such as location obtained directly from the vehicle in question, compares location data obtained from two independent sources and makes a determination as to whether the identification tag pertaining to the vehicle in question is duplicated. This analysis may also compare a time and date when location information was obtained and, optionally, other related information.

Notably, the present technology can serve as an instrument for obtaining information in a way not infringing on citizens” privacy rights, constitutional rights, or any other applicable laws. In some embodiments, the technology provides various clearance levels for the users of the technology. Specifically, there may be provided one clearance level for the general public, another clearance level for merchants, yet another clearance level for security firms, yet another clearance level for police officers and government officials, and so forth. In one example embodiment, the technology may provide the general public with the lowest clearance level, which means they may not need to use credentials to access certain types of information from third parties, such as basic vehicle description and display of status. Accordingly, the general public may have some limitations as to what information can be delivered to them through the use of the present technology. On the other hand, a higher level of clearance may be given to authorities or police officers meaning they need to have credentials to access and run the methods and functionalities as described herein. In return, the police officers may have access to information without any limitations or with fewer limitations. In some embodiments, access to the methods and functionalities of the present technology may require prior user authentication and authorization, for example, based upon biometric information (e.g., fingerprints, retina or iris images, face images) or a two-step authorization technique.

One aspect of the present technology relates to the maintaining of online services for storing vehicle related information. More specifically, there are provided one or more web servers, which have a first database of vehicle statuses and a second database of registered vehicles. The first database includes merely vehicle statuses (i.e., a stolen status, wanted status, parked status, in-travel status, etc.), while the second database includes vehicle registration data, vehicle description data, user comments associated with various vehicles, and so forth.

At least one of these databases is a “crowdsourcing” data collection meaning that the content stored in the database is solicited by contributions from a large group of people—online community or general public—rather than from traditional employees or suppliers. However, in some embodiments, the databases may relate to government databases or proprietary databases maintained by a limited number of people. In either case, the databases are tamper proof through the use of private and public keys, encryption, cryptography, challenge response mechanisms, and tracking of quota and asynchronous calls, among other mechanisms. Accordingly, the insertion of new vehicles into the databases is a safe process as long as the above security mechanisms are implemented.

Furthermore, aspects of the instant technology provides for mechanisms for remote watercraft identification and mooring facilitation. More specifically, this technology helps a captain of a watercraft in communication with authorities of a marina and reserving a dock for mooring. In this disclosure, the term “mooring” shall mean docking a vehicle, such as a watercraft, in a dock, slip, or parking slot. The terms a dock, slip, and parking slot can be used interchangeably and shall mean a dedicated location or area for mooring, docking, or parking a vehicle, such as a watercraft. The term “marina” shall mean any basin or port suitable for docking or parking vehicles, including watercrafts of any size and nature. The term “captain” shall mean a captain, officer, agent, vehicle owner, or any other individual authorized to make decisions associated with mooring or parking of the vehicle (watercraft).

In this technology, the watercraft is equipped with a vehicle identification tag, which can emit a vehicle identification signal convening a vehicle identifier. A captain or officer of the watercraft uses a first electronic device associated with the watercraft and maintained substantially on the watercraft. The first electronic device can be a smart phone or a computing device with a wireless communication interface and having a dedicated software application facilitating implementation of the methods described herein. The first electronic device can acquire and process the vehicle identification signal. For example, the first electronic device can receive the vehicle identification signal and retrieve the vehicle identifier. The first electronic device can be in wireless communication with one or more servers or online services.

The marina authorities can be equipped with a second electronic device such as a smart phone or a computing device configured to wirelessly communicate directly or indirectly with the first electronic device and one or more servers. The second electronic device can be a smart phone or a computing device with a wireless communication interface and having a dedicated software application facilitating implementation of the methods described herein. The second electronic device is maintained substantially on premises of the marina. The term “premises” shall mean a predetermined geographical area, location, or at least a part of building associated with a marina. The second electronic device has a software (mobile) application facilitating the implementation of the methods described herein.

Thus, when a captain of the watercraft intends to moor the watercraft in the marina, he uses the first electronic device associated with the watercraft and maintained substantially on the watercraft. The captain uses the first electronic device to generate and send a mooring request to the first electronic device. The mooring request can include the vehicle identifier and credentials of the captain and optionally any other information, including watercraft information, crew information, passenger information, cargo information, watercraft documentation, watercraft insurance information, and so forth. The mooring request can also include the term of the mooring (e.g., one hour, one night, two nights, a week, a month, etc.). The mooring request can include certain additional requirements such as a requirement for gas, consumable water, electricity, supply, and so forth. In some embodiments, the vehicle identification signal is transmitted to the second electronic device or the server by the first electronic device. The communication between the first electronic device and the second electronic device can include any wireless communication link, including, but not limited to, cellular communication, radio communication, satellite communication, optical communication, and so forth.

When the second electronic device receives the vehicle identification signal and the mooring request, the second electronic device can verify the watercraft by addressing to a database of registered vehicles, and also verify the captain, and/or obtain (and display) any other watercraft-related information. The second electronic device then generates a contract offer based on information provided in the mooring request. The contract offer includes a price estimate for the services of the marina. The second electronic device or the server then sends a response message with at least some details of the contract offer, including the price estimate, to the first electronic device for display and acceptance. When the captain receives response message, he can accept it or decline it (or communicate further with the marina and optionally adjust his requirements so as to adjust the contract offer). The captain uses a user interface of the first electronic device and makes an input (e.g., clicks a button) to indicate that he accepts or rejects the contract offer. If the contract offer is accepted by the captain, the first electronic device generates and sends a confirmation message to the second electronic device or server. In response to the confirmation message, the second electronic device or server makes a record in the database of registered vehicles, optionally makes (or causes to make) a monetary transaction for the marina services using a payment processing service, allocates a dock for mooring the watercraft based on watercraft parameters and the mooring inquiry, and sends map data to the first electronic device. The map data includes a plan of the marina and an indication of the dock allocated for mooring. The map data can be used for manual or automatic navigation of the watercraft to the allocated dock for mooring.

This technology further helps the owners of watercrafts to monitor the location and operation of their watercrafts. For these ends, the first electronic device can repeatedly acquire a current geographical location of the watercraft and also acquire the vehicle identification signal emitted by the vehicle identification tag. The vehicle identification signal includes the vehicle identifier. Further, the first electronic device can be in direct or indirect communication with the database of registered vehicles (or similar database). The first electronic device can also generate, acquire or store one or more past routes taken by the watercraft. The routes can include geographical routes linked to geographical coordinates. The first electronic device repeatedly sends (or upon captain's command) a report message, including the current geographical location, the vehicle identifier, and optionally at least one past route taken by the watercraft. The report message can also include information about a destination port (marina). The report message can also include information about a departure port (marina). The report message can also include directions or a route of the watercraft. The database of registered vehicles stores this information in association with an account of the watercraft, account of the captain, or account of the watercraft owner. The watercraft owner can access one or more of these accounts using his electronic device to monitor the current location and status of the watercraft to see if it is docked, on travel, stolen, wanted, and so forth. The watercraft owner can also examine where the watercraft is travelling to or intends to travel. To access the account of the watercraft owner, the account of the watercraft, or the account of the captain, the watercraft owner may need to input his credentials (e.g., login and password, or biometric information), upon which the watercraft owner can be identified and authenticated. The access to the account of the watercraft owner, the account of the watercraft, or the account of the captain, can also depend on a clearance level of the watercraft owner. With the lowest clearance level, the information provided to the watercraft owner will be limited. In contrast, with the highest clearance level, the information provided to the watercraft owner will have no limitations.

Furthermore, certain individuals, such as customers, prospective customers, marina officials, and crew members can learn more about a watercraft to be docked or currently docked in a marina. For these ends, these individuals can use the second electronic device to obtain the vehicle identifier from the vehicle identification tag. Further, the vehicle identifier can be used by the second electronic device to access the server with the database of registered vehicles and acquire information associated with the watercraft. This information can include data about watercraft parameters and characteristics, mooring parameters, mooring contract, current location, captain information, crew information, owner information, watercraft documentation, watercraft insurance information, and so forth.

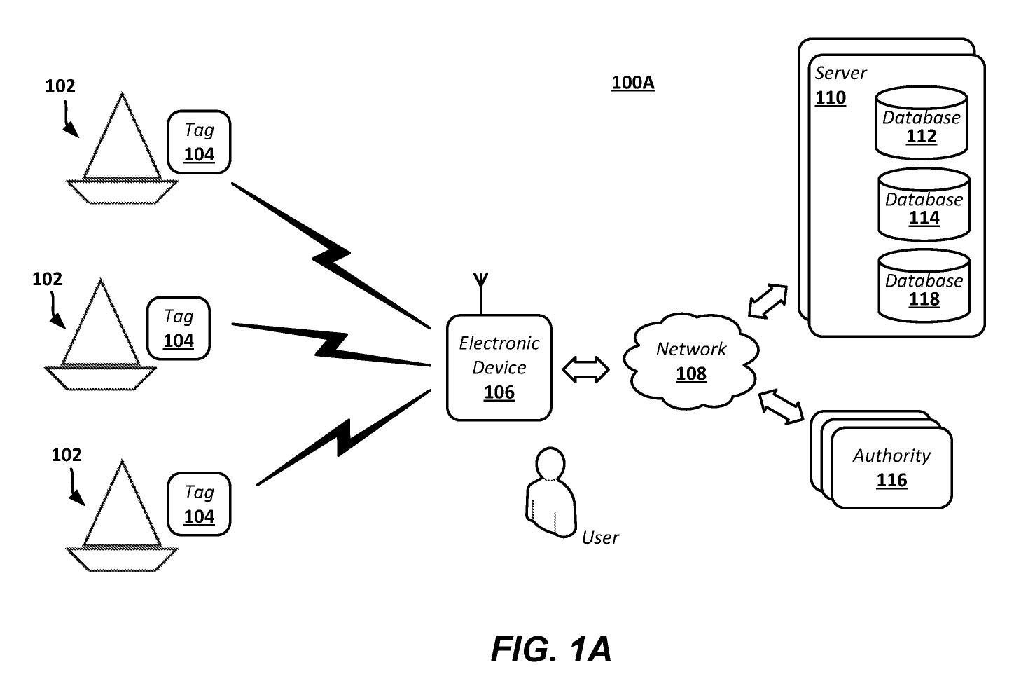

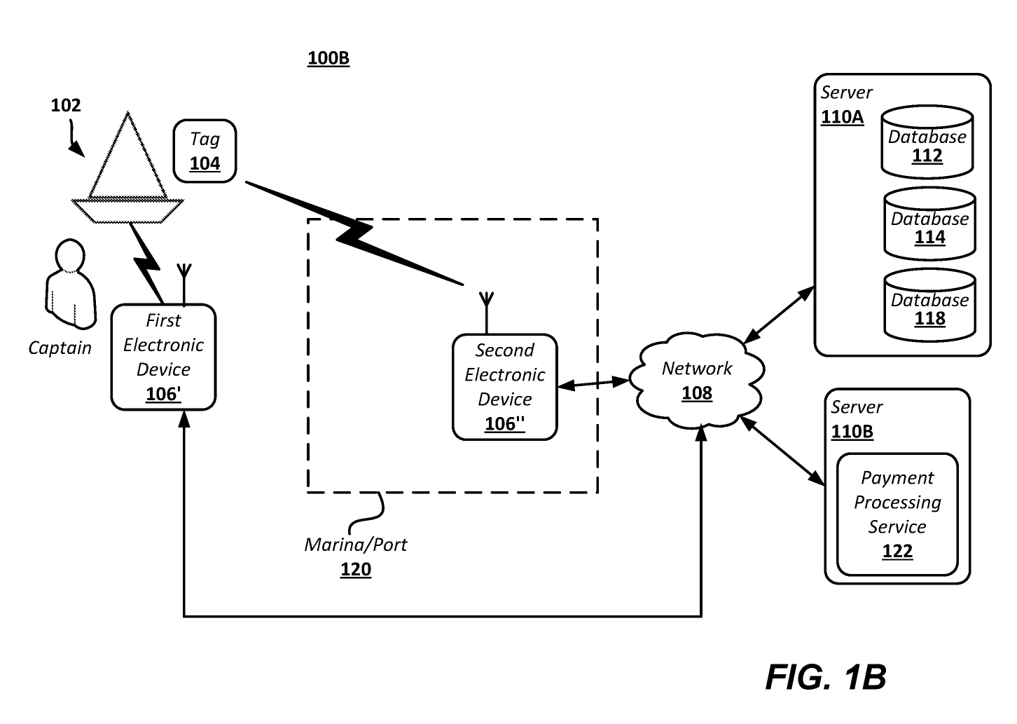

FIG. 1A shows a high-level block diagram illustrating a system environment 100A within which methods for vehicle identification and payment processing may be implemented, in accordance with an example embodiment. In particular, there are shown a number of motor watercrafts 102, each of which is equipped with an identification tag 104. The term “vehicle,” as used herein, refers to any water-floating apparatus suitable for transferring passengers or cargo by water; this may include, without limitation, ships, boats, watercrafts, yachts, and the like. In certain embodiments, however, the technology can be extended to other types of vehicles such as automobiles or aircraft.

The identification tags 104 may include, for example, RFID tags, labels, or transponders, as well as wireless transmitters, portable communication devices, Wi-Fi emitter tags, Bluetooth emitter tags, and so forth. In case of RFID tags, the identification tags 104 may be of passive or active types. Passive identification tags 104 are powered by and read at short ranges via magnetic fields so that they emit electromagnetic waves conveying certain information. In other words, the passive identification tag 104, when powered, emits an identification signal. Active identification tags 104 are powered by a local power source, such as a battery, and repeatedly emit an identification signal.

According to various embodiments, the identification signal includes at least a vehicle identifier (vehicle identifier refers, for example, to a unique alphanumeric code). In certain embodiments, the identification signal may also include other information such as a plate number and vehicle registration data, among other things. In some embodiments, the vehicle identifier can include a unique code which is dynamically changed based on a predetermined principle, which prevents misappropriation of vehicle identifier for crime purposes. The predetermined principle for changing the unique code can be known to the identification tag 104 and a server maintaining a database of registered vehicles. In some embodiments, however, the identification tag 104 can have a receiver, such as a receiver of signals transmitted by a satellite-based communication system. The receiver of identification tag 104 can dynamically receive unique codes so that these unique codes match with codes stored by the server maintaining the database of registered vehicles.

It should be also noted that the identification tags 104 emit identification signals with a limited short-range area. In some examples, the area of identification signal propagation is limited to 300 feet, although it is limited to 100 feet or even less in other example embodiments. The identification tags 104 are secured to the watercrafts 102 in designated places. In one example, the tags 104 can be attached to or be an integral part of a license plate or a windshield sticker.

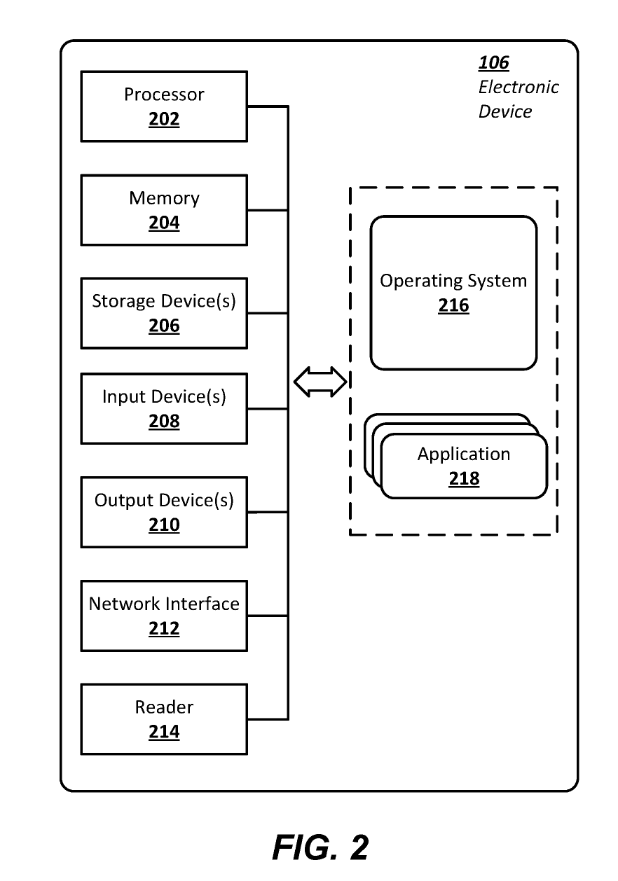

Still referencing to FIG. 1A, there is provided an electronic device 106, which may refer, without limitation, to a portable computing device, tablet computer, laptop computer, general-purpose computer, netbook, mobile phone, smart phone, personal digital assistant (PDA), video recording system, and surveillance system, among others. The electronic device 106 is further described below and shown in FIG. 2. The electronic device 106 may be in possession of an individual (user), such as an employee of marina, watercraft owner, watercraft captain, an officer of government authority, an officer or agent of non-government authority, and the like. In other embodiments, the electronic device 106 may be an integral part of a parking meter or a tollgate.

In general, the electronic device 106 is configured to wirelessly communicate with the identification tags 104. This may include powering and activating passive identification tags 104 by emitting electromagnetic waves and receiving responses from identification tags (i.e., identification signals). In other example embodiments, the electronic device 106 passively aggregates identification signals from active identification tags 104. The electronic device 106 can be in communication with the identification tags 104 only when the electronic device 106 is within a predetermined proximity from the identification tags 104.

Upon receipt of the identification signals from the identification tags 104, the electronic device 106 processes them to retrieve vehicle identifiers associated with the watercrafts 102. Further, the vehicle identifiers are used to obtain vehicle status data. In one example, the electronic device 106 inquires its own database of vehicle statuses (not shown) with the vehicle identifiers to determine if one of the watercrafts 102 is stolen or wanted, or to retrieve vehicle registration data or related information. In another example, the electronic device 106 inquires, via a communication network 108, a server 110. The server 110 maintains a database, such as a database 112 of vehicle statuses, although the server 110 can maintain other databases including, but not limited to, a database 114 of registered vehicles containing vehicle registration data, state inspection data, information associated with outstanding fines or tickets, prior offences or traffic violation data, vehicle owner accounts, or a combination thereof. In some embodiments, the server 110 maintains a parking database 118, which includes a list of parking spot statuses. In some embodiments, the servers run crowdsourcing software to allow the public to solicit content of the databases 112, 114, 118. In some other embodiments, the server 110 may include, be an integral part of, or in some other way be associated with the National Motor Vehicle Title Information System (NMVTIS), National Crime Information Center (NCIC), and Captain and Vehicle Licensing Agency (DVLA), among others.

In either case, the server 110 acquires the vehicle identification from the electronic device 106 and sends back a response conveying a partial record stored in the database 112 of vehicle statuses and optionally records from other databases such as the database 114. In a most simple case, the response contains a vehicle status like “Pass” or “Fail,” which may be coded in a single bit message element. In other words, the response includes information as to whether or not a particular watercraft 102 is listed in the database 112 of vehicle statuses. Thus, the electronic device 106 determines, based upon the server's response, the vehicle status and may display it on its screen, generate an alert audio or video message, generate a report, and the like. The user of the electronic device 106 may report the vehicle status to one or more of authorities 116 in certain cases, such as when a stolen vehicle is identified. Authorities 116 refers, without limitation, to a police department, Federal Bureau of Investigation (FBI), private security provider or firm, military, NMVTIS, NCIC, DVLA, or a combination thereof.

FIG. 1B shows a high-level block diagram illustrating a system environment 100E within which methods for remote watercraft identification and mooring facilitation may be implemented, in accordance with another example embodiment. The environment 100E involves a marina (port) 120. A watercraft 102, which is equipped with an identification tag 104, can visit the marina 120. The identification tag 104 of watercraft 102 may include, for example, a RFID tag, label, or transponder, as well as wireless transmitter, portable communication device, Wi-Fi emitter tag, Bluetooth emitter tag, and so forth. In case of a RFID tag, the identification tag 104 may be of passive or active type. Passive identification tag 104 can be powered by and read at short ranges via magnetic fields so that they emit electromagnetic waves conveying certain information. In other words, the passive identification tag 104, when powered, emits an identification signal. An active identification tag 104 can be powered by a local power source, such as a battery, and repeatedly emit an identification signal.

A captain or officer of the watercraft 102 can be associated with one or more electronic devices. For example, the captain of watercraft 102 can use a first electronic device 106′, which may refer, without limitation, to a portable computing device, tablet computer, laptop computer, general-purpose computer, netbook, mobile phone, smart phone, PDA, and the like. The first electronic device 106′ is configured to scan and read radio signals emitted by the identification tags 104 installed on the watercraft 102. In some embodiments, the first electronic device 106′ is configured to wirelessly communicate with the identification tags 104. This may include powering and activating passive identification tags 104 by emitting electromagnetic waves and receiving responses from identification tags (i.e., identification signals). In other example embodiments, the first electronic device 106′ passively aggregates identification signals from active identification tags 104. Moreover, in some embodiments, the first electronic device 106′ can directly communicate with identification tags 104. In other embodiments, the first electronic device 106′ indirectly communicates with identification tags 104, which involves one more intermediary devices or systems such as cellular communication interface, radio communication interface, satellite communication interface, optical communication interface, and so forth.

The authorities of marina 120 can be associated with one or more electronic devices. For example, one or more employees, officers or agents of the marina can use a second electronic device 106″, which may refer, without limitation, to a portable computing device, tablet computer, laptop computer, general-purpose computer, netbook, mobile phone, smart phone, PDA, and the like. The second electronic device 106″ is configured to scan and read radio signals emitted by the identification tags 104. In some embodiments, the second electronic device 106″ is configured to wirelessly communicate with the identification tags 104. This may include powering and activating passive identification tags 104 by emitting electromagnetic waves and receiving responses from identification tags (i.e., identification signals). In other example embodiments, the second electronic device 106″ passively aggregates identification signals from active identification tags 104. Moreover, in some embodiments, the second electronic device 106″ can directly communicate with identification tags 104. In other embodiments, the second electronic device 106″ indirectly communicates with identification tags 104, which involves one more intermediary devices or systems such as cellular communication interface, radio communication interface, satellite communication interface, optical communication interface, and so forth. In yet other embodiments, the second electronic device 106″ aggregates identification signals from identification tags 104 via another electronic device such as a first electronic device 106′.

Upon receipt of the identification signals from the identification tags 104, the first electronic device 106′ or second electronic device 106″ processes them to retrieve vehicle identifiers associated with the watercrafts 102 or their owners or captains. Further, the first electronic device 106′ can make an inquiry, via the communication network 108, to the second electronic device 106″ or the server 110A. The server 110A maintains a database, such as a database 112 of vehicle statuses, although the server 110A can maintain other databases including, but not limited to, a database 114 of registered vehicles containing vehicle registration data, state inspection data, information associated with outstanding fines or tickets, prior offences or traffic violation data, watercraft accounts, captain accounts, watercraft owner accounts, or a combination thereof. In some embodiments, the server 110A maintains a parking database 118 which includes a list of parking spot statuses (e.g., statuses of docks in one or more marinas or ports). The database 114 of registered vehicles can also include a plurality of accounts. Each of the accounts can be associated with a particular watercraft 102 and its owner, crew, and/or captain. Each of the accounts can include watercraft information (e.g., make and model of watercraft, production year, color, type, watercraft identification number, etc.), owner personal information (e.g., name, address, photograph, contact information, etc.), captain personal information (e.g., name, address, photograph, contact information, etc.), billing information (e.g., credit card details, billing address, banking information, etc.), and/or records (logs) of past purchases (e.g., past monetary and non-monetary transactions for the mooring or parking services in one or more marinas). Each of the accounts can be access by a user based on a clearance level of this particular user.

As shown in FIG. 1B, first electronic device 106′ can also be in operative communication with the server 110A such that the owner or captain of watercraft 102 can access his account stored in the database 114. For these ends, the first electronic device 106′ can have a dedicated mobile (software) application or browser to communicate with the server 110A.

Similarly, the marina 120 can have an account stored in the database 114 or in any other database. The account of the marina 120 can include marina business information (e.g., name, address, photograph, contact information, website, etc.), billing information (e.g., banking information, credit card processor, etc.), and/or records of past monetary and non-monetary transactions for the marina services such as docking, mooring, repairs, and the like. For these ends, the second electronic device 106″ can have a dedicated mobile (software) application or browser to communicate with the server 110A.

Thus, when the watercraft 102 comes to a predetermined proximity of the marina 120, the first electronic device 106′ or second electronic device 106″ can obtain the vehicle identifier from the identification tag 104 and make an inquiry to the database 114 to verify the watercraft 102. The inquiry includes the vehicle identifier retrieved from the vehicle identification signal received from the identification tag 104. In response, the database 114 can return to the second electronic device 106″, watercraft information for further display on the second electronic device 106″. The vehicle information can include one or more of the following: a make of the watercraft, model of watercraft, production year of the watercraft, color of the watercraft, type of the watercraft, identification number of the watercraft, owner personal information (e.g., name, address, photograph, contact information, etc.), captain personal information (e.g., name, address, photograph, contact information, etc.), crew personal information (e.g., names, addresses, photographs, contact information, etc.), billing information (e.g., credit card details, billing address, banking information, etc.), and/or records of past purchases (e.g., past monetary and non-monetary transactions of the captain or owner associated with one or more marinas or any other merchants).

The environment 100B also employs a server 110B having a payment processing service 120. In some embodiments, the server 110A can be the same as the server 110B. The payment processing service 120 can be an online payment processing service configured to process monetary or non-monetary transactions based on billing information provided by the marina via the second electronic device 106″. The billing information can include data about goods or services to be purchased (e.g., goods/services codes) and optionally amount of goods or services to be purchased, price of goods or services to be purchased, and any other information required for the transaction. In some embodiments, the data about goods or services to be purchased can be automatically incorporated into the billing information by reading bar codes or QR-codes, or by retrieving this information from an internal or remote database. The term “payment processing service” shall mean any device, system or software application configured to perform a transaction by exchanging data with financial institutions, banks or other entities. The services of the marina that can be purchased refer to docking services, mooring services, repair services, services related to supplying electricity, water, food, security services, cleaning services, accommodation services, and so forth. The goods of the marina that can be purchased refer to foods, drinks, apparel, watercraft-related items, and so forth.

The payment processing service 120 can also be in communication with the first electronic device 106′, for example, for purposes of requesting a confirmation of the transaction. For example, the payment processing service 120 can cause, through one or more other servers, the first electronic device 106′ to display a user interface showing at least a part of the billing information and prompting the captain (owner) to confirm the transaction by clicking a button, entering an alphanumeric code, reading a fingerprint, and the like.

In some embodiments, the payment processing service 120 can also be in communication with the first electronic device 106′ for purposes of requesting a confirmation of the transaction. In this implementation, the payment processing service 120 can cause the first electronic device 106′ or second electronic device 106″ to display a user interface showing at least a part of the billing information and prompting the captain or owner of the watercraft to confirm the transaction by clicking a button, entering an alphanumeric code, reading a fingerprint, and the like.

FIG. 2 is a high-level block diagram illustrating an example electronic device 106 (including the second electronic device 106″ and the first electronic device 106′) suitable for implementing methods described herein. In particular, the electronic device 106 may be used for vehicle identification and identification of vehicle status. The electronic device 106 may include, be, or be an integral part of one or more of a variety of types of devices, such as a general-purpose computer, desktop computer, laptop computer, tablet computer, netbook, mobile phone, smartphone, PDA, vehicle computer, infotainment system, security device, and surveillance device, smart television device, among others. Furthermore, the electronic device 106 may be an integrated part of another multi-component system such as a vehicle monitoring systems. In yet more embodiments, the electronic device 106 may be an integrated part of a parking meter or tollgate. Notably, FIG. 2 illustrates just one example of the electronic device 106 and in some embodiments the electronic device 106 may have fewer elements/modules than shown on FIG. 2 or more elements/modules than shown on FIG. 2.

As shown in FIG. 2, the electronic device 106 includes one or more processors 202, a memory 204, one or more storage devices 206, one or more input devices 208, one or more output devices 210, network interface 212, and a reader 214 (e.g., an antenna, interrogator, or reading device for RFID tags 104). One or more processors 202 are, in some examples, configured to implement functionality and/or process instructions for execution within the electronic device 106. For example, the processors 202 may process instructions stored in memory 204 and/or instructions stored on storage devices 206. Such instructions may include components of an operating system 216 or software application(s) 218. Electronic device 106 may also include one or more additional components not shown in FIG. 2, such as a housing, power supply, battery, global positioning system (GPS) receiver, payment module (e.g. credit card reader or coin slot), and so forth.

Memory 204, according to one example, is configured to store information within the electronic device 106 during operation. Memory 204, in some example embodiments, may refer to a non-transitory computer-readable storage medium or a computer-readable storage device. In some examples, memory 204 is a temporary memory, meaning that a primary purpose of memory 204 may not be long-term storage. Memory 204 may also refer to a volatile memory, meaning that memory 204 does not maintain stored contents when memory 204 is not receiving power. Examples of volatile memories include random access memories (RAM), dynamic random access memories (DRAM), static random access memories (SRAM), and other forms of volatile memories known in the art. In some examples, memory 204 is used to store program instructions for execution by the processors 202. Memory 204, in one example, is used by software (e.g., the operating system 216) or applications 218. Generally, applications 218 refer to software applications suitable for implementing at least some operations of the methods for vehicle identification or processing payments based on remote vehicle identification as described herein.

One or more storage devices 206 can also include one or more transitory or non-transitory computer-readable storage media and/or computer-readable storage devices. In some embodiments, storage devices 206 may be configured to store greater amounts of information than memory 204. Storage devices 206 may further be configured for long-term storage of information. In some examples, the storage devices 206 include non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Still referencing to FIG. 2, the electronic device 106 may also include one or more input devices 208. The input devices 208 may be configured to receive input from a user through tactile, audio, video, or biometric channels. Examples of input devices 208 may include a keyboard, keypad, mouse, trackball, touchscreen, touchpad, microphone, one or more video cameras, image sensors, fingerprint sensors, or any other device capable of detecting an input from a user or other source, and relaying the input to electronic device 106, or components thereof. Additional examples of input devices 208 include depth sensors, lidars, remote sensors, and so forth. Though shown separately in FIG. 2, the reader 214 may, in some instances, be a part of input devices 208. It should be also noted that the reader 214 may be a peripheral device operatively connected to the electronic device 106 via the network interface 212.

The output devices 210, in some examples, may be configured to provide output to a user through visual or auditory channels. Output devices 210 may include a video graphics adapter card, a liquid crystal display (LCD) monitor, a light emitting diode (LED) monitor, an organic LED monitor, a sound card, a speaker, a lighting device, a LED, a projector, or any other device capable of generating output that may be intelligible to a user. Output devices 210 may also include a touchscreen, presence-sensitive display, or other input/output capable displays known in the art.

The electronic device 106, in some example embodiments, also includes network interface 212. The network interface 212 can be utilized to communicate with external devices via one or more networks such as one or more wired, wireless, or optical networks including, for example, the Internet, intranet, local area network (LAN), wide area network (WAN), cellular phone networks (e.g. Global System for Mobile (GSM) communications network, packet switching communications network, circuit switching communications network), Bluetooth radio, and an IEEE 802.11-based radio frequency network, among others. The network interface 212 may be a network interface card, such as an Ethernet card, an optical transceiver, a radio frequency transceiver, or any other type of device that can send and receive information. Other examples of such network interfaces may include Bluetooth®, 3G, 4G, LTE, and Wi-Fi radios in mobile computing devices.

The operating system 216 may control one or more functionalities of electronic device 106 and/or components thereof. For example, the operating system 216 may interact with the applications 218 and may facilitate one or more interactions between the applications 218 and one or more of processors 202, memory 204, storage devices 206, input devices 208, and output devices 210. As shown in FIG. 2, the operating system 216 may interact with or be otherwise coupled to the application(s) 218 and components thereof. In some embodiments, application(s) 218 may be included in operating system 216. In these and other examples, virtual modules, firmware, or software for vehicle identification may be part of the applications 218. In other examples, virtual modules, firmware, or software for vehicle identification may be implemented externally to electronic device 106, such as at a network location. In some such instances, electronic device 106 may use the network interface 212 to access and implement functionalities provided by virtual modules, firmware, or software for vehicle identification through methods commonly known as “cloud computing.”

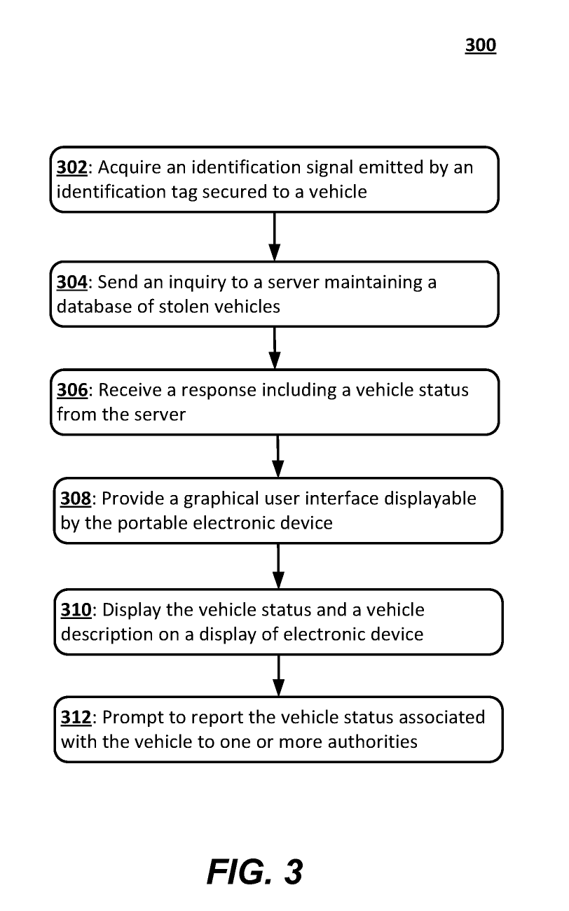

FIG. 3 shows a high-level process flow diagram of a method 300 for vehicle identification according to one exemplary embodiment. The method 300 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 300 is implemented by the electronic device 106 shown in FIGS. 1A, 1B and 2; however, it should be appreciated that the method 300 is just one example operation of the electronic device 106. In addition, the below recited steps of the method 300 may be implemented in an order different than described and shown in FIG. 3. Moreover, the method 300 may have additional steps not shown herein, but which can be evident for those skilled in the art from the present disclosure. The method 300 may also have fewer steps than outlined below and shown in FIG. 3.

The method 300 commences at step 302 with the electronic device 106 acquiring an identification signal emitted by an identification tag 104 secured to a motor watercraft 102. As described above, the identification signal conveys a vehicle identifier in the form of alphanumeric code or base 64 encoding. Optionally, the identification signal further includes additional information such as vehicle registration information, and/or plate number, among other things. At step 304, the electronic device 106 sends an inquiry to the server 110, which maintains a database such as the database 112 of vehicle statuses. The inquiry may simply contain the vehicle identifier retrieved from the identification signal and, optionally, other data. In some embodiments, the same or similar inquiry can be sent to the database 114 of registered vehicles to obtain additional information associated with the vehicle in question. At step 306, the electronic device 106 receives a response from the server 110 with a vehicle status from the database 112 with a basic description of the vehicle and optionally, according to clearance levels, additional data such as vehicle registration information, list of outstanding fines or tickets, list of offences associated with the watercraft 102 or a combination thereof, from the database 114. The vehicle status bears the information as to whether the watercraft 102 is stolen, wanted, suspicious, subject for inspection in view of other reasons, parked, and so forth. Thus, the electronic device 106 determines whether the watercraft 102 is listed in the database 112 of vehicle statuses. If the watercraft 102 is listed, then the electronic device 106 determines whether the status is pass or fail. If the watercraft 102 is not listed, the signal emitted is considered an altered signal and is reported as an invalid vehicle identifier (VID).

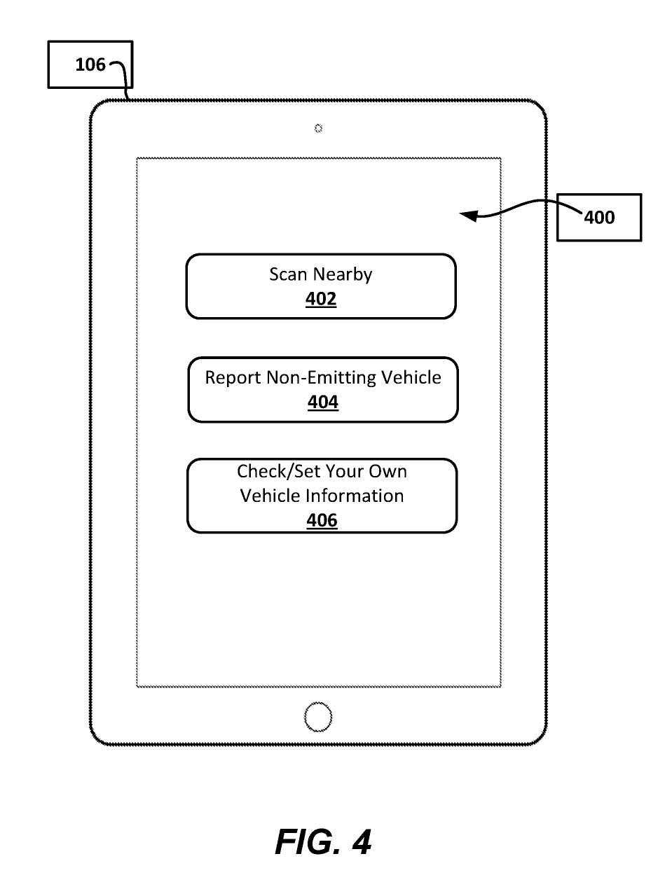

Further, at step 308, the electronic device 106 provides a GUI and displays it on a display of the electronic device 106. Exemplary GUIs are discussed below with reference to FIGS. 4-10. At step 310, the electronic device 106 displays, through the GUI, the vehicle status for attention of the user and optionally other information associated with the vehicle. At step 312, the electronic device 106 prompts the user to report the vehicle status to one of the authorities 116. The reporting includes sending an electronic message or alert via the network 108.

FIGS. 4-10 illustrate schematic diagrams of GUIs displayable by the electronic device 106 at different stages of vehicle status identification. As shown in these drawings, the electronic device 106 is a tablet computer; however, the same or similar GUIs may be provided for other types of electronic devices 106 such as desktop or laptop computers, cellular telephones, and so forth.

FIG. 4 shows a GUI 400 displayable at the time of activation of an application 218 for vehicle identification. In an example embodiment, the interface 400 includes actionable messages (buttons) or hyperlinks. Namely, these are “Scan Nearby” button 402 and “Report Non-Emitting Vehicle” button 404. When the user presses the button 402, the method 300 is activated and similarly, by pressing the button 404, at least some steps of a method for reporting non-emitting vehicles are implemented. “Check/Set Your Own Vehicle Information” button 406 allows the user with login credentials to check and set information of vehicles the user owns.

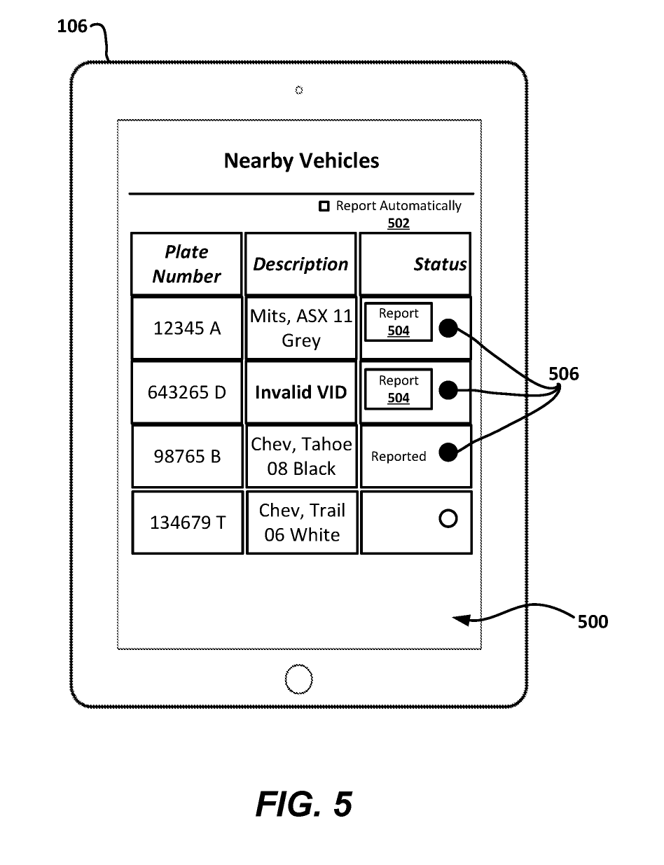

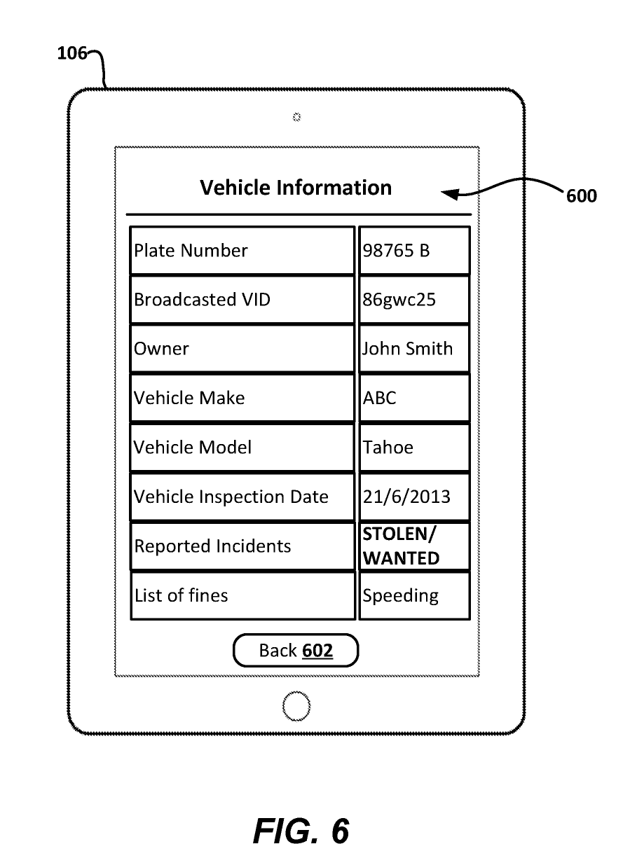

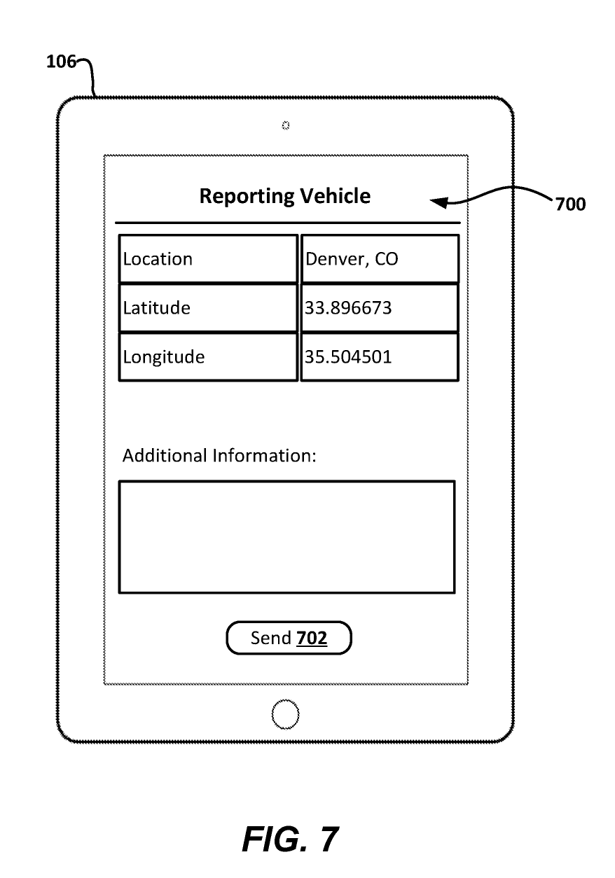

FIG. 5 shows a GUI 500 displayable in response to a press of the button 402. In particular, the GUI 500 shows the results of the method 300 for vehicle identification, which includes a tray (output box) where a table is presented. The table shows vehicle plate numbers of located vehicles, basic descriptions of vehicles, and vehicle statuses as acquired from the server. As shown in the figure, one of the table string lists “Invalid VID” meaning that the vehicle with the plate number “643265 D” is emitting a VID that is not listed in the database of vehicle statuses and thus requires special attention by competent authorities. One of the table strings lists a vehicle with a black dot 506 and plate number “12345 A” meaning that the vehicle with plate number “12345 A” is listed in the database with a Wanted/Stolen status reflected on the interface by the black dot 506. A “Report” button 504 can be used by the user in order to report the vehicle on the same row of the table of the GUI 700 shown on FIG. 7. As shown on FIG. 5, the vehicle with plate number “98765 B” with the black dot 506 has already been reported by the user of device 106. A “Report Automatically” button 502 can be used by the user of device 106 to choose for the device 106 to report automatically about suspicious vehicles that are within the range area. Each string in the table may be actionable according to levels of clearance. For example, upon the user pressing on the line showing “987265 D” as a plate number, the GUI is replaced with a GUI 600 shown in FIG. 6.

As illustrated in FIG. 6, the GUI 600 contains a table with detailed information regarding the selected watercraft 102. This GUI is reached only by users with proper clearance levels. The information may include, but is not limited to, vehicle registration data, plate number, owner's name, date of last state inspection, vehicle make, vehicle model, vehicle color, vehicle year, vehicle's representable image, list of reported incidents or accidents, list of offences associated with the vehicle or vehicle's owner, or a combination thereof. The GUI 600 also includes one actionable button: a “Back” button 602 to return to the previous GUI 500.

FIG. 7 shows a GUI 700 displayable in response to the press of the button 504 shown on FIG. 5. FIG. 7 illustrates the GUI 700 suitable for reporting to one or more authorities 116. The GUI 700 includes a tray showing multiple fields with information subject for inclusion into a report. This may include, but is not limited to, location information, plate number, vehicle identifier, vehicle registration data, and additional information. Upon the user pressing a “Send” button 702, the electronic device 106 transmits the report to one or more of the authorities 116.

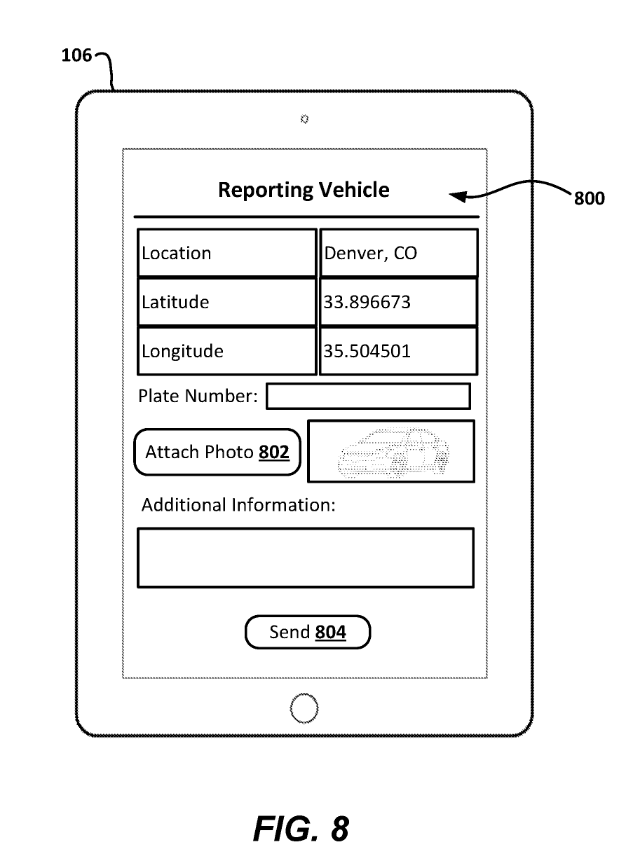

FIG. 8 shows a GUI 800 displayable in response to the press of the button 404. In particular, the GUI 800 relates to a method of reporting to the authorities 116 when a suspicious vehicle is identified by the user as not emitting any signal. Similar to FIG. 7, the GUI 800 shown in FIG. 8 has a tray for showing what information will be included or subject to inclusion in a report message. This includes, without limitation, location information, vehicle registration data (if available), plate number (which can be input by the user), a photo of the suspect vehicle (which can be added by the user when an “Attach Photo” button 802 is activated), and additional information (as can be input by the user). Upon the user pressing a “Send” button 804, the electronic device 106 transmits the report to the one or more of the authorities 116.

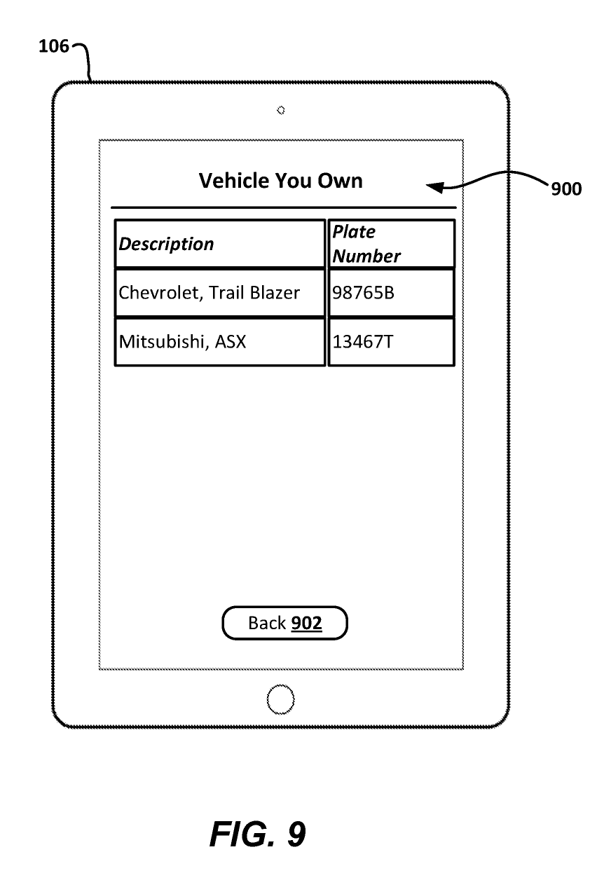

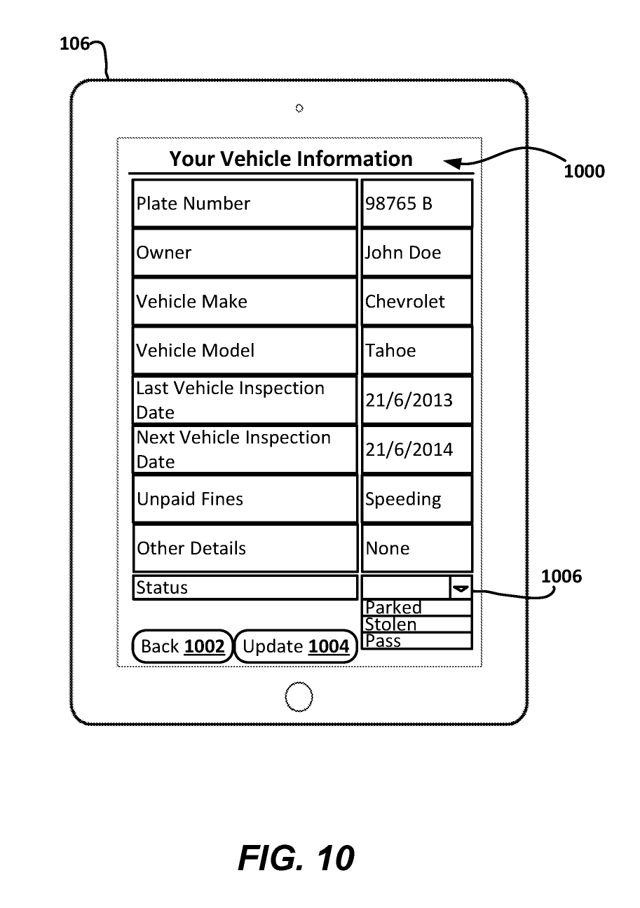

FIG. 9 shows a GUI 900 displayable in response to the press of the button 406 shown on FIG. 4. The GUI 900 displays a list of vehicles owned by the user currently logged into the system with specific secure credentials. The GUI 900 displays a table of strings with basic vehicle description and plate numbers. The GUI 900 also includes one actionable button: a “Back” button 902 to return to the previous GUI 400. Each string in the table may be actionable. For example, upon the user pressing on the line showing “98765B” as a plate number, the GUI 900 is replaced with a GUI 1000 shown on FIG. 10.

FIG. 10 shows a GUI 1000 displaying the user information about a particular vehicle the user owns. Information includes unpaid fines, last vehicle inspection date, next vehicle inspection date, and so forth. The GUI 1000 also includes an actionable button or drop down button 1006 for the user to set the status of the user own vehicle, such as parked, stolen, pass, and the like. Note that when user changes his vehicle status, a request is routed to authorities and after proper approval, the status of the vehicle will be effective. The GUI 1000 also includes an actionable “Update” button 1004 that the user needs to press in order to update, in the database, the new status of the user vehicle chosen by activation of button 1006. The GUI 1000 also includes an actionable “Back” button 1002 to go to the previous GUI 900.

As discussed above, the database 114 of registered vehicles may maintain multiple accounts, with each associated with a particular vehicle. Each account may include records of a vehicle identifier, a vehicle plate number, vehicle information, vehicle owner information (e.g., name, mailing address, contact data), current vehicle status, payment information (e.g., credit card details, billing address), and billing records associated with prior charges for parking, traffic violations, toll roads, and or past purchases made with one or more merchants using the remote vehicle identification.

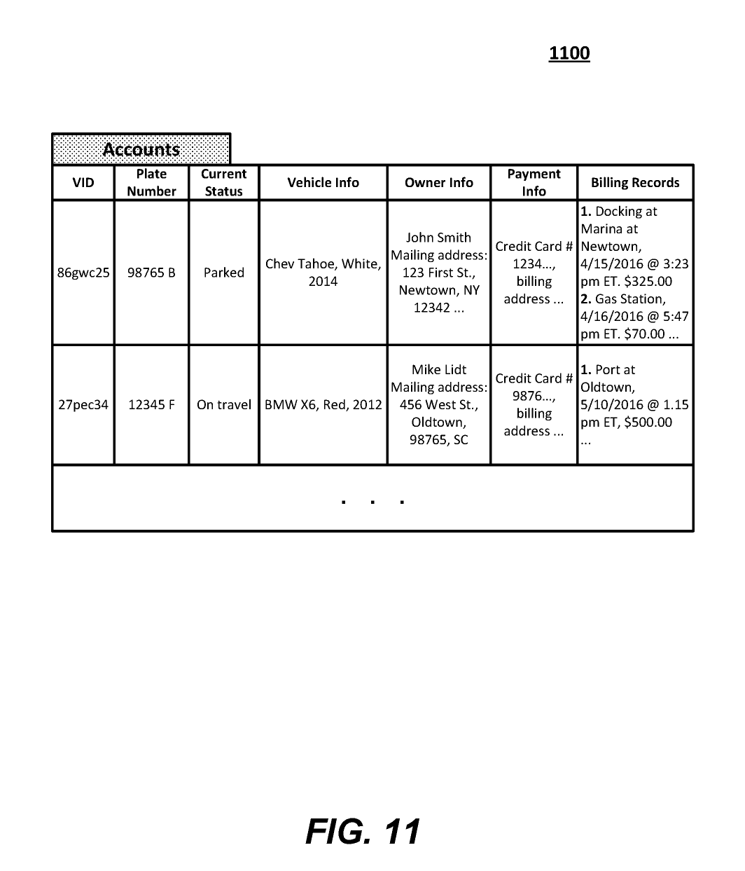

FIG. 11 shows an exemplary data structure 1100 of database 114 of registered vehicles. The database 114 can be maintained by a server such as a server 110 so that multiple electronic devices 106 may have access to it when needed. Notably, vehicle owners may edit some or all information provided in their corresponding accounts. For example, the owners may edit their personal information, payment information, contact information, and so forth.

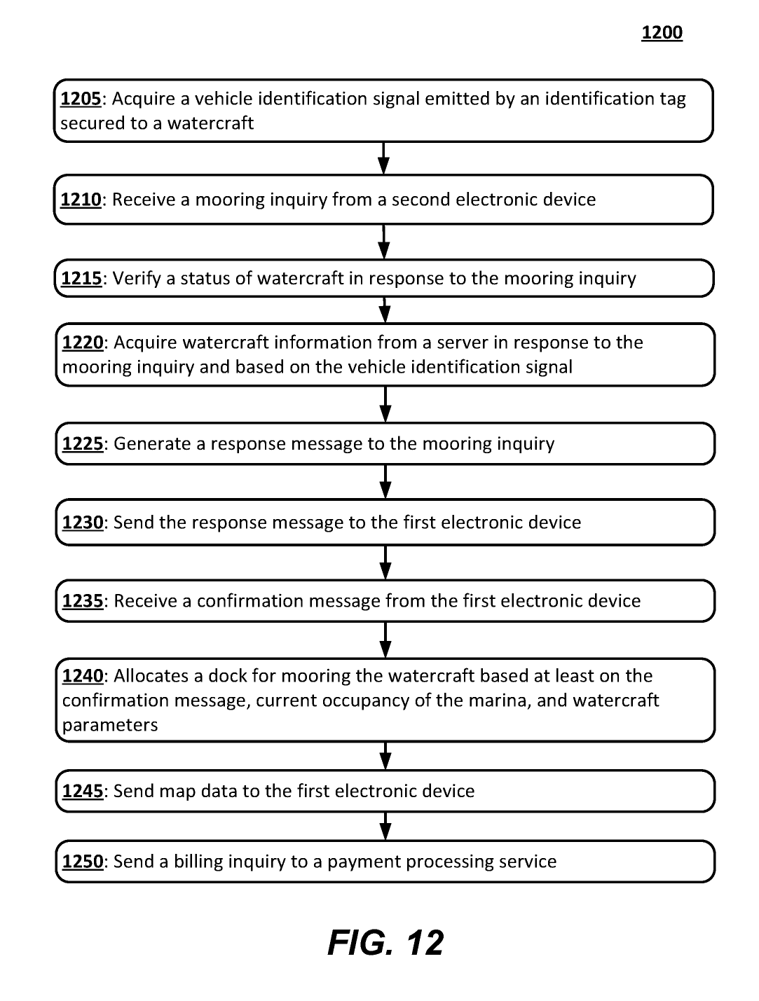

FIG. 12 shows a high-level process flow diagram of a method 1200 for remote watercraft identification and mooring facilitation, according to one exemplary embodiment. The method 1200 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 1200 is implemented by devices of environment 100B shown in FIG. 1B and FIG. 2. Importantly, the below recited steps of the method 1200 may be implemented in an order different than described and shown in FIG. 12. Moreover, the method 1200 may have additional steps not shown herein, but which can be evident for those skilled in the art from the present disclosure. The method 1200 may also have fewer steps than outlined below and shown in FIG. 12.

The method 1200 commences at step 1205 with a first electronic device 106′ acquiring a vehicle identification signal emitted by a vehicle identification tag 104 secured to a watercraft 102. The vehicle identification signal conveys a vehicle (watercraft) identifier associated with the watercraft. The first electronic device 106′ is associated with the watercraft 102 and can be operated by the captain of the watercraft 102. Normally, the first electronic device 106′ is maintained substantially on the watercraft 102. The first electronic device 106′ can generate a mooring inquiry upon input of the captain and send the mooring inquiry to a second electronic device 106″ or server 110A.

At step 1210, the second electronic device 106″ or server 110A receives the mooring inquiry from the first electronic device 106′. The second electronic device 106″ is associated with the marina 120 and maintained substantially on premises (i.e., a territory) of the marina 120. The mooring inquiry comprises vehicle identifier, credentials of the captain of the watercraft 102 and optionally one or more of the following: mooring information such as desired term of stay, watercraft location, preferable mooring location, watercraft parameters, certain requests for goods or services, and so forth. The mooring inquiry is normally generated by the captain using a graphical user interface of the first electronic device 106′.

At step 1215, the second electronic device 106″ or server 110 verifies, in response to the mooring inquiry, a status of watercraft based on the vehicle identification signal or vehicle identifier. The verification can be performed through the server 110A maintaining a database 114 of registered vehicles (or any other database). The verification can provide to the second electronic device 106″ an actual status of the watercraft 102 (i.e., if it is wanted, stolen, on travel, etc.).

Moreover, at step 1220, the second electronic device 106″ acquires, in response to the mooring inquiry, watercraft information based on the vehicle identification signal. The watercraft information can be acquired from the server 110A maintaining the database 114 of registered vehicles (or any other database). The watercraft information can include watercraft parameters, watercraft crew information, watercraft documentation, watercraft insurance information, and contact information.

At step 1225, the second electronic device 106″ generates a response message to the mooring inquiry. The response message comprises a price estimation associated with a contract offer for mooring services and any other services or goods to be provided by the marina 120. The price estimation can be manually inputted by agents or officers of the marina or automatically generated based on the mooring request.

At step 1230, the second electronic device 106″ or server 110A sends the response message to the first electronic device 106′. The response message causes the first electronic device 106′ to display a graphical user interface that shows the contract offer, the price estimation, and prompts the captain of the watercraft 102 to make an input indicating his acceptance or denial of the contract offer.

At step 1235, the second electronic device 106″ or server 110A receives a confirmation message from the first electronic device 106′. The confirmation message includes the acceptance or denial of the contract offer.

If the contract offer was accepted, at step 1240, the second electronic device 106″ or server 110A allocates a dock for mooring the watercraft 102 based on the confirmation message, current occupancy of the marina, watercraft parameters (e.g., its length and width) acquired based on the vehicle identification signal, and optionally other information such as a captain request, marina parameters, and so forth.

At step 1245, the second electronic device 106″ or server 110A sends to the first electronic device 106′, electronic map data. The map data comprises a plan of the marina 120 and an indication of the dock allocated for mooring the watercraft 102. Moreover, in some embodiments, the second electronic device 106″, server 110A or the first electronic device 106′, can perform or facilitate navigation of the watercraft based on the map data and current geographical location of the watercraft 102 determined by the first electronic device 106′.

At step 1250, the second electronic device 106″ or server 110A sends a billing inquiry to a payment processing service 122. The billing inquiry can comprise the vehicle identifier and billing information. The price estimation can be based on the price estimation or contract offer. The billing inquiry causes the payment processing service 122 to perform a monetary or non-monetary transaction based on the billing information and in accordance with one or more predetermined rules and against an account associated with an owner or the captain of the watercraft 102. The billing information can include data about goods or services to be purchased (e.g., goods/services codes) and optionally amount of goods or services to be purchased, price of goods or services to be purchased, and any other information required for the transaction. In some embodiments, the data about goods or services to be purchased can be automatically incorporated into the billing information by reading bar codes or QR-codes, or by retrieving this information from an internal or remote database. The payment processing service 122 performs the transaction by exchanging data with financial institutions, banks or other entities. The services of the marina that can be purchased refer to docking services, mooring services, repair services, services related to supplying electricity, water, food, security services, cleaning services, accommodation services, and so forth. The goods of the marina that can be purchased refer to foods, drinks, apparel, watercraft-related items, and so forth.

The method 1200 can further helps the owner of watercraft 102 to monitor the location and operation of the watercraft 102. For these ends, the first electronic device 106′ can repeatedly (dynamically) acquire a current geographical location of the watercraft 102, track one or more routes of the watercraft 102, and acquire the vehicle identification signal emitted by the vehicle identification tag 104 secured to the watercraft 102. Further, the first electronic device 106′ can repeatedly (dynamically) send a report message to the server 110A maintaining the database 114 of registered vehicles. The report message can include the current geographical location of the watercraft associated with the vehicle identifier Server 110A and database 114 can hence construct the past route taken by the watercraft. The owner can later access the database 114 to monitor the status and location of the watercraft 102. To access the database 114 (and the report message particularly), the owner of the watercraft 102 may need to provide his credentials (e.g., a login, user name, password, passcode, and the like). Once the server of the database 114 verifies the owner based on received credentials, the database 114 can return the report messages or other related information based on a clearance level of the owner of the watercraft 102.

Thus, systems and methods for remote watercraft identification and mooring facilitation have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for remote watercraft identification and mooring facilitation, the method comprising:
acquiring, by a first electronic device, a vehicle identification signal emitted by a vehicle identification tag secured to a watercraft, wherein the vehicle identification signal conveys a vehicle identifier associated with the watercraft;
receiving a mooring inquiry by a second electronic device or server from the first electronic device, wherein the mooring inquiry comprises credentials of a captain of the watercraft and the watercraft identification signal;
generating, by the second electronic device or the server, a response message to the mooring inquiry, the response message comprising a price estimation associated with a contract offer for mooring services, the price estimation being based on watercraft parameters returned by the server and on the watercraft identification signal
sending, by the second electronic device or the server, the response message to the first electronic device;
receiving a confirmation message, by the second electronic device or the server from the first electronic device; and
sending map data by the second electronic device or the server to the first electronic device, wherein the map data comprises a plan of a marina and an indication of a dock allocated for mooring the watercraft.

2. The method of claim 1, wherein the second electronic device is associated with the marina and maintained substantially on premises of the marina.

3. The method of claim 1, wherein the first electronic device is associated with the watercraft, the first electronic device being maintained substantially on the watercraft.

4. The method of claim 1, further comprising verifying, in response to the mooring inquiry, a status of watercraft based on the vehicle identification signal, the verification being performed through the server maintaining a database of registered vehicles.

5. The method of claim 1, further comprising acquiring, in response to the mooring inquiry, watercraft information based on the vehicle identification signal, the watercraft information being acquired from the server maintaining a database of registered vehicles, wherein the watercraft information includes watercraft parameters, watercraft crew information, watercraft documentation, watercraft insurance information, and contact information.

6. The method of claim 1, further comprising allocating, by the second electronic device or the server, a dock for mooring the watercraft based on the confirmation message, current occupancy of the marina, and watercraft parameters acquired based on the vehicle identification signal.

7. The method of claim 1, further comprising:
acquiring, by the first electronic device, a current geographical location of the watercraft;
acquiring, by the first electronic device, the vehicle identification signal emitted by the vehicle identification tag secured to the watercraft, wherein the vehicle identification signal conveys the vehicle identifier associated with the watercraft;
sending, by the first electronic device, a report message to the server maintaining a database of registered vehicles, the report message including the current geographical location of the watercraft associated with the vehicle identifier;
providing access to the report message and a past route of the watercraft by the server or the second electronic device to an owner of the watercraft based on credentials of the owner and a clearance level of the owner of the watercraft.

8. The method of claim 1, further comprising sending a billing inquiry, by the first electronic device, to a payment processing service, wherein the billing inquiry comprises the vehicle identifier and billing information, the billing inquiry causing the payment processing service to perform a monetary transaction based on the billing information and in accordance with one or more predetermined rules and against an account associated with an owner or the captain of the watercraft.

9. The method of claim 1, wherein the response message causes the first electronic device to display a user interface, wherein the user interface shows the contract offer, the price estimation, and prompts the captain of the watercraft to make an input indicating his acceptance or denial of the contract offer.

10. The method of claim 1, further comprising navigating, by the first electronic device, the watercraft based on the map data obtained from the second electronic device or the server and current geographical location of the watercraft determined by the first electronic device.

11. A system for remote watercraft identification and mooring facilitation, the system comprising:
a server maintaining a database of registered vehicles;
a second electronic device comprising at least one processor and a memory storing processor-executable codes, wherein the at least one processor is configured to implement the following operations upon executing the processor-executable codes:
receiving a mooring inquiry from a first electronic device, wherein the mooring inquiry comprises a vehicle identifier and credentials of a captain of the watercraft and the watercraft identification signal, wherein the vehicle identifier is acquired by the first electronic device from a vehicle identification signal emitted by a vehicle identification tag secured to a watercraft;
generating a response message to the mooring inquiry, the response message comprising a price estimation associated with a contract offer for mooring services, the price estimation being based on watercraft parameters returned by the server and the watercraft identification signal;
sending the response message to the first electronic device;
receiving a confirmation message from the first electronic device; and
sending to the first electronic device map data, the map data comprising a plan of a marina and an indication of a dock allocated for mooring the watercraft.

12. The system of claim 11, wherein the second electronic device is associated with the marina and maintained substantially on premises of the marina.

13. The system of claim 11, wherein the first electronic device is associated with the watercraft, the first electronic device being maintained substantially on the watercraft.

14. The system of claim 11, wherein the at least one processor of the second electronic device is further configured to implement verifying, in response to the mooring inquiry, a status of watercraft based on the vehicle identification signal, the verification being performed through the server maintaining the database of registered vehicles.

15. The system of claim 11, wherein the at least one processor of the second electronic device is further configured to implement acquiring, in response to the mooring inquiry, watercraft information based on the vehicle identification signal, the watercraft information being acquired from the server maintaining the database of registered vehicles, wherein the watercraft information includes watercraft parameters, watercraft crew information, watercraft documentation, watercraft insurance information, and contact information.

16. The system of claim 11, wherein the at least one processor of the second electronic device is further configured to implement allocating, by the second electronic device, a dock for mooring the watercraft based on the confirmation message, current occupancy of the marina, and watercraft parameters acquired based on the vehicle identification signal.

17. The system of claim 11, wherein the at least one processor of the first electronic device is further configured to implement:
acquire a current geographical location of the watercraft;
acquire the vehicle identification signal emitted by the vehicle identification tag secured to the watercraft, wherein the vehicle identification signal conveys the vehicle identifier associated with the watercraft;
send a report message to the server maintaining the database of registered vehicles, the report message includes the current geographical location of the watercraft associated with the vehicle identifier and
provide access to the report message and a past route of the watercraft by the server or the second electronic device to an owner of the watercraft based on credentials of the owner and a clearance level of the owner of the watercraft.

18. The system of claim 11, wherein the at least one processor of the first electronic device is further configured to implement sending a billing inquiry, by the first electronic device, to a payment processing service, wherein the billing inquiry comprises the vehicle identifier and billing information, the billing inquiry causing the payment processing service to perform a monetary transaction based on the billing information and in accordance with one or more predetermined rules and against an account associated with an owner or the captain of the watercraft.

19. The system of claim 11, wherein the response message causes the first electronic device to display a user interface, wherein the user interface shows the contract offer, the price estimation, and prompts the captain of the watercraft to make an input indicating his acceptance or denial of the contract offer.

20. A non-transitory processor-readable medium having instructions stored thereon, which when executed by one or more processors, cause the one or more processors to implement a method for processing payments based on remote vehicle identification, the method comprising:
receiving a mooring inquiry from a first electronic device, wherein the mooring inquiry comprises a vehicle identifier and credentials of a captain of the watercraft, wherein the vehicle identifier is acquired by the first electronic device from a vehicle identification signal emitted by a vehicle identification tag secured to a watercraft;
generating a response message to the mooring inquiry, the response message comprising a price estimation associated with a contract offer for mooring services;
sending the response message to the first electronic device;
receiving a confirmation message from the first electronic device; and
sending to the first electronic device map data, the map data comprising a plan of a marina and an indication of a dock allocated for mooring the watercraft.
